(19) United States
(12) Patent Application Publication
(10) Pub. No.: US 2024/0003062 A1
(43) Pub. Date: Jan. 4, 2024

(54) GRAPHENE COMPOSITE FIBER AND MANUFACTURING METHOD THEREFOR

(71) Applicant: Yeong Woo LEE, Gyeongsan-si (KR)

(72) Inventor: Yeong Woo LEE, Gyeongsan-si (KR)

(21) Appl. No.: 18/037,070

(22) PCT Filed: Nov. 30, 2020
(86) PCT No.: PCT/KR2020/017333

§ 371 Date: May 15, 2023

(30) Foreign Application Priority Data
Nov. 23, 2020 (KR) 10-2020-0158116

(51) Int. Cl. D01F 9/12; C08K 3/04; C08J 3/205; D01F 1/09; D01D 5/30; D01F 1/10

(52) U.S. Cl. CPC D01F 9/12; C08K 3/042; C08J 3/2053; D01F 1/09; D01D 5/30; D01F 1/10; C08K 2201/011; C08J 2377/00; C08J 2367/02; D01D 5/08

(57) ABSTRACT

Disclosed are a graphene composite fiber and a manufacturing method thereof. The manufacturing method of the graphene composite fiber of the present disclosure includes a first solution preparation step of preparing a first solution by dispersing graphene in a dispersion solvent, a second solution preparation step of preparing a second solution by adding a polymer to the first solution, a graphene master chip preparation step of preparing a plurality of graphene master chips by solidifying and then cutting the second solution, and a graphene composite fiber preparation step of preparing a graphene composite fiber by spinning the plurality of graphene master chips and the polymer by a fiber spinning device.

### CROSS-REFERENCE TO RELATED APPLICATIONS

This application claims the priority of Korean Patent Application No. 10-2020-0158116 filed on Nov. 23, 2020, in the Korean Intellectual Property Office, the disclosure of which is incorporated herein by reference.

### BACKGROUND OF THE INVENTION

### Field of the Invention

The present disclosure relates to a fiber and a manufacturing method thereof, and more particularly, to a graphene composite fiber capable of producing a composite fiber using graphene and a heterogeneous raw material and a manufacturing method thereof.

### Description of the Related Art

Graphene is a material in which carbons are connected to each other in the form of a hexagon to form a honeycomb-shaped 2D planar structure, which is known to have excellent physical strength and excellent thermal conductivity and electrical properties. Recently, due to these excellent properties of graphene, many attempts have been made to apply graphene to transparent electrodes, flexible displays, composite reinforcement materials, filters, biosensors, IC packaging materials, and the like.

Graphene may be largely divided into four synthesis methods thereof. The first method may refer to chemical vapor deposition (CVD) and epitaxial growth. The second method is a scotch tape or peel-off method, and the third method is an epitaxial growth method by electrically insulating the surface. Finally, there is a method of oxidizing through strong chemical oxidation treatment.

<Chemical Vapor Deposition (CVD)>

In 1841, Shaffault first reported a graphite intercalation compound in which K metal was intercalated to graphite, and then many intercalation compounds were obtained by combining intercalations of electron donor and electron acceptor materials such as alkali, alkaline earth, and rare earth metals. Depending on each structure, these intercalation compounds may have either silent superconductivity or catalytic activity. In addition, as the interlayer distance of graphite intercalation compounds (GICs) increases, the van der Waals force decreases, making it very easy to peel graphene from graphite. In addition, in 2003, the Kaner group attempted a vigorous reaction using a solvent such as alcohol on a stage using Kmetal as an intercalation material, and at this time, a semi-stable thin plate of about 30 layers was obtained, and a research result was reported in which the obtained material was changed into a roll form by ultrasonic waves.

<Peel-Off Method>

The method refers to peel-off from graphite crystals formed of weak van der Waals bonds by a mechanical force. Graphene can be prepared by such a method because a surface has a smooth structure when electrons of a pi orbital function are widely distributed on the surface.

The method described above is a method of separating monolayer graphene using the adhesion of a scotch tape. In this method, graphene began to attract attention from researchers around the world by directly measuring, analyzing, and reporting a half-integer quantum Hall effect, which had been presented only in theory.

<Chemical Exfoliation Method>

The chemical exfoliation method means dispersing graphene pieces exfoliated from graphite crystals in a solution through chemical treatment. When graphite is oxidized and then pulverized using ultrasonic waves and the like, it is possible to make graphene oxide uniformly dispersed in an aqueous solution, and when a reducing agent such as hydrazine is used here, graphene having no oxidation structure and excellent crystallinity may be obtained. However, in the case of the final graphene obtained above, even if a reducing agent is used, due to a disadvantage that a reduction process is not completely performed, a much reduced electrical property is caused when applied to devices. On the other hand, in the case of graphene separated using a surfactant, etc., compared to graphene obtained through the aforementioned reduction process, the electrical properties are improved, but there is a disadvantage that a practical level of sheet resistance characteristics is not shown due to interlayer resistance between graphene pieces.

<Epitaxy Method>

This method means that carbons adsorbed or included in the crystals at a high temperature grow into graphene along the texture of the surface.

Among the methods, the peel-off method belongs to a top-down method, and the other methods belong to a bottom-up method.

Graphene obtained by the top-down method has excellent crystallinity (high conductivity and low defects), but has low production efficiency, which is not sufficient for practical applications. In addition, there are disadvantages in that there is a possibility to be contaminated with organic impurities, and it is difficult to control the number of graphene layers.

In the bottom-up method, the number of graphene layers and growth factors may be controlled using various types of substrates. In particular, large-area, high-quality, and high-purity graphene can be produced using the CVD synthesis method, enabling mass production.

Recently, the CVD synthesis method is most commonly used to mass-produce high-quality graphene films. The CVD synthesis method is a bottom-up method in which graphene is directly grown on a substrate using a carbon source such as methane. Large-area monolayer graphene grown on a catalytic metal foil such as copper may be transferred to a desired target substrate.

The above-described technical configuration is the background art for helping in the understanding of the present disclosure, and does not mean a conventional technology widely known in the art to which the present disclosure pertains.

### SUMMARY OF THE INVENTION

The present disclosure has been made in an effort to provide a graphene composite fiber that can express the characteristics of graphene by adding a small amount of graphene to a polymer and can be mass-produced, and a manufacturing method thereof.

According to an aspect of the present disclosure, there is provided a manufacturing method of a graphene composite fiber including a first solution preparation step of preparing a first solution by dispersing graphene in a dispersion solvent; a second solution preparation step of preparing a second solution by adding a polymer to the first solution; a graphene master chip preparation step of preparing a plurality of graphene master chips by solidifying and then cutting the second solution; and a graphene composite fiber preparation step of preparing a graphene composite fiber by spinning the plurality of graphene master chips and the polymer by a fiber spinning device.

In the first solution preparation step, the plurality of graphene master chips may be included in an amount of 0.03 to 0.4 parts by weight.

The dispersion solvent may contain ethylene glycol.

During the spinning, a solid state polymerization process may be performed, and in the solid state polymerization process, the content of a lubricant may be 70 to 80 wt % in the emulsion.

In the solid state polymerization process, a low wick chemical may have a weight average molecular weight of 2,868 and a PDI of 1.2 of an active ingredient.

When supplying the low wick chemical, water and an emulsifier may be added to increase the diffusion efficiency of the chemical.

The polymer may include one selected from polyester, nylon 6, nylon 66, polypropylene, polyethylene, composite yarn (N/C, P/C), carbon fibers, Aramid fibers, and mono fibers.

According to another aspect of the present disclosure, there is provided a graphene composite fiber manufactured by one method described above.

The graphene composite fiber may include nylon 2.9 denier or polyethylene terephthalate (RV 0.80) 1.7 denier.

According to the present disclosure, a plurality of graphene master chips are manufactured using 0.3 to 1.5 nano graphene and a polypolymer or nylon polymer and a graphene composite fiber is manufactured by spinning the plurality of graphene master chips together with a polypolymer or nylon polymer by a fiber spinning device, thereby exhibiting characteristics of graphene by adding a small amount of graphene to the polymer and mass-producing graphene composite fibers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically illustrating a manufacturing method of a graphene composite fiber according to an embodiment of the present disclosure;

FIG. 2 is a schematic diagram schematically illustrating the manufacturing method illustrated in FIG. 1;

FIG. 3 is a diagram illustrating a graphene composite fiber manufactured according to the embodiment;

FIG. 4 is a table illustrating a comparison between a graphene composite fiber manufactured according to the embodiment and a general fiber; and

FIG. 5 is a table illustrating a comparison between a graphene composite fiber manufactured according to the embodiment and a general PP.

### DETAILED DESCRIPTION OF THE PREFERRED EMBODIMENT

In order to fully understand the present disclosure, operational advantages of the present disclosure and objects to be achieved by implementing the present disclosure, the present disclosure will be described with reference to the accompanying drawings which illustrate preferred embodiments of the present disclosure and the contents illustrated in the accompanying drawings.

Hereinafter, preferred embodiments of the present disclosure will be described in detail with reference to the accompanying drawings. Like reference numerals illustrated in the respective drawings designate like members.

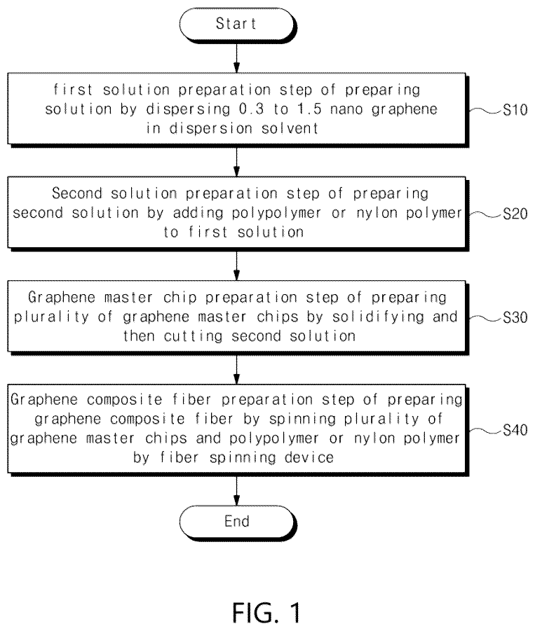

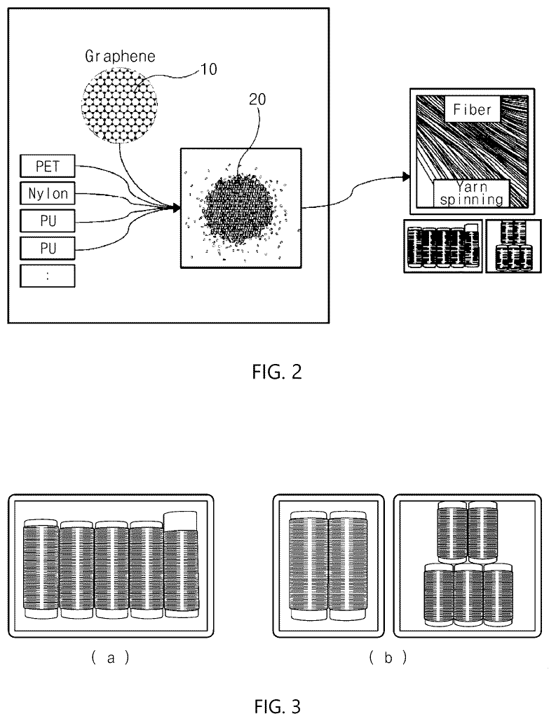

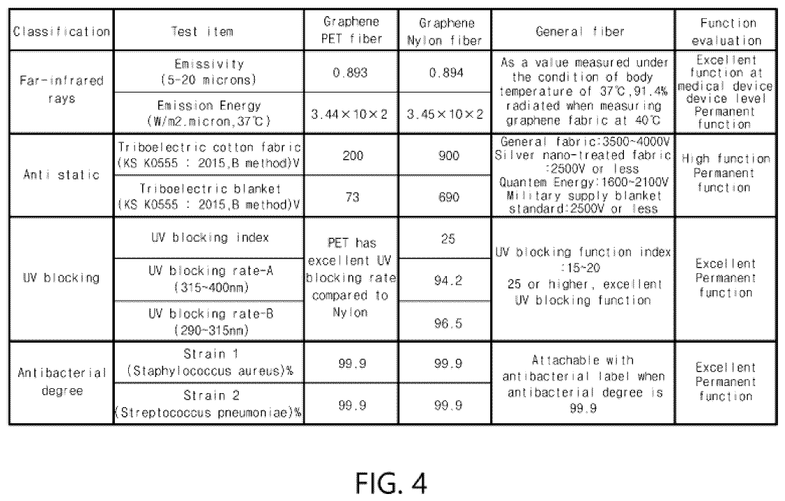

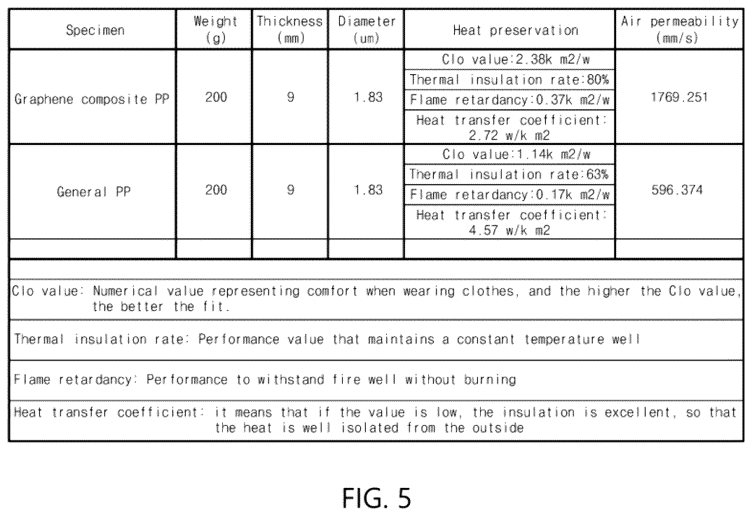

FIG. 1 is a diagram schematically illustrating a manufacturing method of a graphene composite fiber according to an embodiment of the present disclosure, FIG. 2 is a schematic diagram schematically illustrating the manufacturing method illustrated in FIG. 1, FIG. 3 is a diagram illustrating a graphene composite fiber manufactured according to the embodiment, FIG. 4 is a table illustrating a comparison between a graphene composite fiber manufactured according to the embodiment and a general fiber, and FIG. 5 is a table illustrating a comparison between a graphene composite fiber manufactured according to the embodiment and a general PP.

As illustrated in these drawings, the manufacturing method of the graphene composite fiber according to the embodiment includes a first solution preparation step (S10) of preparing a first solution by dispersing 0.3 to 1.5 nano graphene 10 in a dispersion solvent; a second solution preparation step (S20) of preparing a second solution by adding a polypolymer or nylon polymer to the first solution; a graphene master chip preparation step (S30) of preparing a plurality of graphene master chips 20 by solidifying and then cutting the second solution; and a graphene composite fiber preparation step (S40) of preparing a graphene composite fiber by spinning the plurality of graphene master chips 20 and the polypolymer or nylon polymer by a fiber spinning device.

The first solution preparation step (S10) is a step of preparing the first solution by dispersing the 0.3 to 1.5 nano graphene 10 in the dispersion solvent.

In the embodiment, the dispersion solvent may include an organic solvent. For example, the organic solvent may be any one of ethylene glycol, dimethyl sulfoxide (DMSO), n-methyl-2-pyrrolidone (NMP) and dimethylformamide (DMF).

In addition, in the embodiment, a stirring process may be performed on the solvent added with the graphene 10 in order to improve the dispersibility of the graphene 10 in the solvent.

Furthermore, in the embodiment, the graphene 10 may have an average diameter of about 20 to 200 nm or 50 to 500 nm.

The second solution preparation step (S20) is a step of preparing the second solution by adding the polypolymer or nylon polymer to the first solution.

In the embodiment, polyurethane may also be added to the second solution in addition to the polypolymer or nylon polymer.

The graphene master chip preparation step (S30) is a step of preparing a plurality of graphene master chips 20 by solidifying and cutting the second solution.

In the embodiment, as illustrated in FIG. 2, the plurality of graphene master chips 20 may be prepared using the 0.3 to 1.5 nano graphene 10 and the polypolymer or nylon polymer.

The plurality of graphene master chips 20 prepared above may be supplied to a fiber spinning device and manufactured into a graphene composite fiber by melt extrusion in the fiber spinning device.

The graphene composite fiber preparation step (S40) is a step of preparing the graphene composite fiber by spinning the plurality of graphene master chips 20 and the polypolymer or nylon polymer with the fiber spinning device.

In the step of preparing the graphene composite fiber of the embodiment, the plurality of graphene master chips 20 may be provided in an amount of 0.03 to 0.4 parts by weight.

In addition, in the embodiment, the fiber spinning device may manufacture a graphene composite fiber by using a melt extrusion method.

The graphene composite fiber manufactured according to the embodiment may be polyethylene terephthalate (RV 0.80) 1.7 denier, which is a graphene composite PET fiber illustrated in FIG. 3A, and may also be nylon 6 2.9 denier, which is a graphene composite nylon fiber illustrated in FIG. 3B. FIG. 3A illustrates 0.2% graphene composite PET fibers, and FIG. 3B illustrates 0.2% and 0.05% graphene composite nylon fibers.

As illustrated in FIG. 4, it can be seen that the graphene composite PET fibers and the graphene composite nylon fibers manufactured according to the embodiment are superior in far-infrared rays, anti-static, UV blocking, and antibacterial effects compared to general fibers.

In addition, as illustrated in FIG. 5, it can be seen that the graphene composite polypolymer fibers manufactured according to the embodiment are superior in terms of Clo value, thermal insulation rate, flame retardancy, heat transfer coefficient, air permeability, etc. compared to general polypolymer fibers.

Meanwhile, polyester industrial yarn is yarn having high-strength properties and is manufactured by melt-spinning a high molecular weight polymer to increase the degree of orientation and crystallinity of the yarn. Since there is a limit to increase the molecular weight only with general melt polymerization, molecular weight and intrinsic viscosity capable of exhibiting high-strength properties may be obtained through solid state polymerization.

In the solid state polymerization process, after agglomeration is prevented through surface crystallization in a crystallization step, the polymerization reaction is performed by rising to a temperature capable of solid state polymerization. In the melt polymerization, since the polymerization reaction is performed in a molten state, diffusion is fast and thus, there is almost no difference in molecular weight and intrinsic viscosity.

However, in the case of the solid state polymerization, the reaction rate is determined by the diffusion of end groups and the transfer rate of reaction by-products, but since the solid state polymerization is performed in a solid state, there is a problem that the speed is slow and the difference in molecular weight and intrinsic viscosity may increase due to various conditions of the solid state polymerization. Such a difference causes a difference in the degree of orientation between filaments of the fiber during melt spinning, which causes breakage in the filaments having a high degree of orientation where drawn stress is concentrated. As a result, a maximum draw ratio, which is a measure of drawability, may be lowered.

In the embodiment, an effect of crystallization conditions was improved except for other conditions of solid state polymerization. Here, through observation with a polarized optical microscope, a spherulite shape was confirmed in the crystallization step of the solid state polymerization on the inside as well as on the surface of the resin (chip). The solid state polymerization is divided into batch and continuous processes, but in the case of the batch process, the spherulite shape is uniform, whereas in the continuous process, various types of spherulites have been found.

The structure formed in the crystallization step was maintained until the end of solid state polymerization, but due to the difference in spherulite structure between chips, the diffusion rate of end groups and reaction by-products and the reaction rate of solid state polymerization may vary, and as a result, it was confirmed that differences in molecular weight and viscosity (intrinsic viscosity and melt viscosity) were caused.

As a result, it was confirmed that a difference in the orientation degree of undrawn yarn (before Godet Roller 1) occurred in the melt spinning process and thus, the maximum draw ratio was lowered, that is, the drawability was deteriorated. The continuous process is a process adopted by most manufacturers because of high productivity and manufacturing cost competitiveness. Due to the characteristic of the process, the continuous process had a relatively high crystallization temperature condition. In this case, the temperature of first and second crystallization baths was lowered by 15° to secure a uniform spherulite shape like in the batch process, thereby reducing the variations in melting temperature, molecular weight, intrinsic viscosity, and melt viscosity of the chips to increase the maximum draw ratio, which is a measure of drawability, from 6.28 to 6.71.

Polyester low wick yarn is industrial yarn widely used for PVC coated fabrics of billboards and playground roofs. Since the application to be used requires shape stability, the yarn needs to have physical properties of high strength and low shrinkage, and is used after being exposed to the outside air for a long time to have excellent low wick properties to prevent deterioration in quality such as stains caused by moisture penetration. The manufacturing cost competitiveness is the most important factor for the commercialization of low wick yarn.

To secure the manufacturing cost competitiveness, it is necessary to apply a 1-step high-speed spinning process and minimize pickup of an expensive low wick chemical, which accounts for the largest portion in the increase in manufacturing cost. This process is a process of supplying an emulsion (Spin Finish) before drawing, exhibiting the physical properties of the fiber through drawing and heat treatment, and then supplying a low wick chemical at high speed (about 3,000 m/min) before winding. The low wick yarn forms a thin layer of an emulsion and a low wick chemical on the surface of the fiber, but since the process is a high-speed process and the fiber has a large surface area (192 filaments), there is a problem that it is very difficult to evenly distribute the low wick chemical on the emulsion layer.

To solve the problem, it is necessary to optimize an interface between the emulsion and the low wick chemical, and each design is important. In the case of a low wick chemical prepared by emulsion polymerization, the surface energy varies when the low wick chemical is supplied in the spinning process and when a fluoropolymer as an active ingredient remains on the surface of the fiber after water is evaporated. Considering this aspect, the hydrophobicity of the emulsion was increased by increasing the content of a lubricant from 45% to 75% within the applicable range for industrial fiber spinning. In the case of the low wick chemical, the surface tension of the polymer was lowered by lowering the weight average molecular weight of the active ingredient to 2,868 and the Polydispersity Index (PDI, molecular weight distribution) to 1.2 to improve the interfacial compatibility between the active ingredients of the low wick chemical.

In addition, when supplying the low wick chemical, water and an emulsifier are added to make a mixture in order to increase the diffusion efficiency of the chemical. This mixture includes 70% or more of water and has high surface energy. Therefore, the physical diffusion was facilitated by installing an interlace process immediately after supplying the low wick chemical mixture. Through this, it was confirmed that the low wick chemical was evenly dispersed on the surface of the fiber with a small particle size.

In addition, a change in surface morphology before and after heat treatment was confirmed, but it was confirmed that when the molecular weight of the active ingredient of the low wick chemical was low, the melting point was lowered and the low wick performance was additionally improved due to an increase in coverage when PVC was coated on the fabric in a post-process. Through this, finally, polyester industrial low wick yarn having excellent low wick property of 40 mm or less at 0.8% of the low wick chemical pickup, excellent form stability of strength of 8.0 g/d or more and shrinkage rate of 3% or less, and manufacturing cost competitiveness may be manufactured.

As described above, according to the embodiment, the plurality of graphene master chips are manufactured using the 0.3 to 1.5 nano graphene and the polypolymer or nylon polymer and the graphene composite fiber is manufactured by spinning the plurality of graphene master chips together with the polypolymer or nylon polymer by the fiber spinning device, thereby exhibiting characteristics of graphene by adding a small amount of graphene to the polymer and mass-producing graphene composite fibers.

According to the embodiment, it is possible to exhibit the characteristics of graphene by adding a small amount of graphene to a polymer, and mass-produce graphene composite fibers.

As described above, the present disclosure is not limited to the embodiments described herein, and it will be apparent to those skilled in the art that various changes and modifications may be made without departing from the spirit and the scope of the present disclosure. Therefore, it will be determined that the changed examples or modified examples are included in the appended claims of the present disclosure.

1. A manufacturing method of a graphene composite fiber comprising:
a first solution preparation step of preparing a first solution by dispersing graphene in a dispersion solvent;
a second solution preparation step of preparing a second solution by adding a polymer to the first solution;
a graphene master chip preparation step of preparing a plurality of graphene master chips by solidifying and then cutting the second solution; and
a graphene composite fiber preparation step of preparing a graphene composite fiber by spinning the plurality of graphene master chips and the polymer by a fiber spinning device.

2. The manufacturing method of the graphene composite fiber of claim 1, wherein in the first solution preparation step, the plurality of graphene master chips is included in an amount of 0.03 to 0.4 part by weight.

3. The manufacturing method of the graphene composite fiber of claim 1, wherein the dispersion solvent contains ethylene glycol.

4. The manufacturing method of the graphene composite fiber of claim 1, wherein during the spinning, a solid state polymerization process is performed, and in the solid state polymerization process, the content of a lubricant is 70 to 80 wt % in the emulsion.

5. The manufacturing method of the graphene composite fiber of claim 4, wherein in the solid state polymerization process, a low wick chemical has a weight average molecular weight of 2,868 and a PDI of 1.2 of an active ingredient.

6. The manufacturing method of the graphene composite fiber of claim 4, wherein when supplying the low wick chemical, water and an emulsifier are added to increase the diffusion efficiency of the chemical.

7. The manufacturing method of the graphene composite fiber of claim 1, wherein the polymer includes one selected from polyester, nylon 6, nylon 66, polypropylene, polyethylene, composite yarn (N/C, P/C), carbon fibers, Aramid fibers, and mono fibers.

8. A graphene composite fiber manufactured by the method of claim 1.

9. The graphene composite fiber of claim 8, wherein the graphene composite fiber includes nylon 2.9 denier or polyethylene terephthalate (RV 0.80) 1.7 denier.
